(19) United States
(12) Patent Application Publication
(10) Pub. No.: US 2020/0189173 A1
(43) Pub. Date: Jun. 18, 2020

(54) Pivotable Flipper for Thermoforming Apparatus for Forming Undercuts in Packaging

(71) Applicant: Portage Plastics Corporation, Portage, WI (US)

(72) Inventors: Julio C. Mendoza, Brownsville, TX (US); Christopher Meier, Portage, WI (US); Anthony Domerchie, Green Oaks, IL (US)

(21) Appl. No.: 16/708,408

(22) Filed: Dec. 9, 2019

Related U.S. Application Data
(60) Provisional application No. 62/743,220, filed on Oct. 9, 2018.

(51) Int. Cl. B29C 51/44; B29C 51/38; B29C 51/20

(52) U.S. Cl. CPC B29C 51/445; B29C 51/20; B29C 51/38

(57) ABSTRACT

A flipper assembly that can be used with a package-producing mold, for instance, a mold that is used during thermoforming procedures. The flipper assembly includes a base mounted to the mold, a flipper arm pivotably connected to the base between a first position where the arm is substantially perpendicular to the height of the base and a second position where the arm is substantially parallel to the height of the base, and a spring mounted to the base and the flipper arm. During the thermoforming process, the flipper arm forms an undercut of finger into the package, which improves the stability and strength of the package. The flipper arm is moved between first and second positions based on linear extension and retraction of the spring.

### CROSS-REFERENCE TO RELATED APPLICATION

This application claims priority to U.S. Provisional Application No. 62/743,220, filed on Oct. 9, 2018, the entire contents of which are hereby expressly incorporated by reference into this application.

### FIELD

The present invention is directed to a flipper that is pivotable relative to a thermoforming mold where the flipper is configured to form an undercut, such as a finger, in a sheet that is being thermoformed into a thermoformed part, such as a thermoformed package.

### BACKGROUND

Many different types of thermoformed parts and components, including packages, can be manufactured quickly, easily, and affordably using thermoforming practices. To do so, a sheet of thermoformable plastic material is heated until the sheet is pliable. During or after heating, the pliable sheet can be pressed, stretched, or sucked using a vacuum into a three-dimensionally contoured of a mold. As a result, the sheet takes the shape of the three-dimensionally contoured cavity formed in the mold, resulting in a three-dimensionally shaped part, e.g., three-dimensionally shaped package, which is similar in shape to the three-dimensional shape of the mold cavity. After being formed into the desired three-dimensional shape, the three-dimensional shape of the part, e.g., package, is set by cooling or allowing it to cool thereby fixing its shape memory after thermoforming in a manner that retains the three-dimensional shape of the part. Depending on the desired characteristics of the part, e.g., package, can be thermoformed from relatively thin sheets having thicknesses ranging between 0.060-0.375 inches or between 1.5-9.5 mm composed of a variety of materials, such as acrylonitrile butadiene styrene (ABS), polycarbonate, high-density polyethylene, polypropylene, polyvinyl chloride (PVC), polyethylene terephthalate (PET or PETG), or styrene.

In many industries, more durable thermoformed packages are desired or required. For instance, many windshield wiper blades are packaged, transported and displayed for retail sale in thermoformed packages. Windshield wiper blades oftentimes are manufactured with a substantially continuous curve, e.g., pre-curved beam-type wiper blades, which results in more uniform contact with a vehicle windshield during wiper operation to improve wiping efficiency. Due to the significant curvature of these types of windshield wiper blades, a thermoformed wiper blade package will need to possess significant strength, including good structural rigidity, in order to hold the pre-curved wiper blade in place. This is especially true given the fact that pre-curved beam wiper blades are typically held by the package in a partially or substantially straightened condition to minimize package volume and maximize retail display package density. In order to hold such a pre-curved beam wiper blade in place in a partially or substantially straightened condition, particularly where the thermoformed package is reclosable, the associated pre-curved beam wiper blade packaging should have features that increase the strength and rigidity of such reclosable packaging and which help retain the reclosable packaging in the closed condition.

As a result, many thermoformed packages, not just reclosable wiper blade packages, include a variety of features molded into the sheet during thermoforming in order to improve the overall strength of the package, especially in areas prone to failure, depending on the contents of the packaging. For instance, many types of packages include features formed during thermoforming that protrude or extend inwardly from various top, bottom, or side walls of the package whose function can vary. Such protruding thermoformed features can be configured not only to improve package strength or rigidity but also to help retain an article in a recessed article-holding compartment of the package, including while the package is closed.

Modern designs of thermoformed parts, including thermoformed packages, increasingly include deeper, longer and ever more aggressive protruding features called undercuts, which typically require attachment of various components to the mold that have a three-dimensionally contoured molding surface disposed in the mold cavity that imparts a like three-dimensional shape to the part of the sheet drawn against it during thermoforming. More extreme types of undercuts can take the form of larger, longer, stronger, and more rigid fingers configured to more securely engage and hold an article within a recessed article-retaining cavity of the package that can also be configured to better resist flexing of the package. In the case of wiper blade packages designed to hold pre-curved beam wiper blades, it is common to thermoform multiple sets of fingers into a single package that extend into the blade-holding compartment and configured not only provide snap-fit engagement with the pre-curved beam of a wiper blade placed in the compartment, but which also make the package more rigid to prevent a cover of the package from coming loose or popping off.

In the past, flipper assemblies have been attached to thermoforming molds that each have a flipper movable relative to the mold and which has a three dimensionally contoured molding surface configured to form a finger in a thermoformed parts, such as thermoformed packaging, e.g., reclosable packaging designed to hold pre-curved beam wiper blades. It has been learned that the more extreme the fingers and undercuts that can be formed into a package, the stronger the overall package will be and the less prone the package will be to popping open.

Flipper assemblies employed in the past to form such fingers and other types of more aggressive undercuts are in the form of a cartridge that is a base of the assembly that is configured to be removably attached to a mold of a thermoforming apparatus. The flipper assembly cartridge or base, e.g., base, has a movable flipper that protrudes outwardly into the mold cavity and which has a three-dimensionally contoured molding face against which part of the sheet is urged and complementarily conforms to form an undercut, preferably a finger, in the part, e.g., package, being thermoformed. The flipper typically is pivotably attached by a pin enabling the flipper to rotate about a pivot formed by the pin, e.g., pivot pin, between a first position or molding position where its molding face is ready for forming in the mold cavity and a second position or a molded component release facilitating position, e.g. part-demolding position, disposed away from the molding position that facilitates removal of a finished thermoformed part from the mold. These flipper assemblies employ a coil spring that extends between the base and flipper to help urge the flipper to pivot back to the molding position after the thermoformed part, e.g., thermoformed package, becomes completely disengaged from the flipper during part demolding.

In the past, such flipper assemblies have suffered from numerous problems and drawbacks, which were magnified by deeper and more aggressive flipper assembly designs increasingly coming into use. One known problem is that over the course of many thermoforming cycles, the flipper return spring becomes increasingly less able to produce enough force to rotate the flipper back to the molding position after demolding of a thermoformed part is completed. Over time, overstretching of the return spring occurs that reduces the ability of the spring to return the flipper back to the molding position because this overstretching disadvantageously reduces the amount of return spring force the spring can generate. When the flipper fails to return back to the molding position before the beginning of the next thermoforming cycle, the next part will be defectively thermoformed because the finger or undercut will not be properly or completely formed. This not only results in monetary losses in the form of an increase in the number of defectively thermoformed parts, but it also requires more frequent and costly thermoforming apparatus downtime to more frequently change the return spring with a new one possessing enough return force to ensure the flipper once again returns to the molding position.

It has also been learned that the orientation and configuration of the flipper of the flipper assembly in the thermoforming mold cavity can also adversely impact finger and undercut formation in a similar manner. While a stronger return spring may be required, some orientations and configurations have proven to be less reliable than others. While use of a stronger spring can sometimes help, it still does not help prevent premature overstretching of the spring such that upside down flipper assembly orientations and configurations where the flipper has an unusual, e.g., non-symmetrical, shape or is bulky also are prone to increased thermoformed part defect rates and undesirably more frequent return spring replacement.

Accordingly, there is a need for an improved mechanism used to form fingers and other undercuts which readily moves out of the way during removal of thermoformed parts, such as during thermoforming of wiper blade packaging, to facilitate part removal and which reliably and consistently homes back to the molding position. There also is a need for an improved mechanism which can be used to form fingers and other undercuts using a pivotable flipper that is biased between a first home or molding position and a second molded part release position to allow the thermoformed part, e.g., thermoformed wiper blade package, to be removed without damaging the thermoformed part, after which the pivotable flipper is returned to the home or molding position.

### SUMMARY

The present invention helps to overcome these issues by providing a flipper assembly that can be used with a thermoforming mold to create high-quality, strong thermoformed parts, preferably thermoformed packages, which have extreme undercuts or fingers, while allowing for the easy removal of the part, preferably package, once the thermoforming process has been completed. In a preferred embodiment and method, the improved flipper assembly of the present invention is used in the making of thermoformed wiper blade packages, which preferably are of reclosable clamshell package construction.

To do so, the flipper assembly includes a base, a flipper arm, and can also employ a flipper arm biasing element that preferably is a spring. In a preferred embodiment, a flipper assembly constructed in accordance with the present invention employs a flipper arm biasing element, which preferably is or includes a spring in tension, configured to rotatively return the flipper arm to a home or molding position after removal of a thermoformed part from the cavity of a thermoforming mold. The base is configured to be mounted to the mold. The flipper arm is pivotably connected to the base about a pivot point and oriented so it is at least partially disposed in the mold cavity when in its home or molding position. The spring has a first end that is attached to the base and a second end attached to the flipper arm. The spring is connected in tension and configured to allow the flipper arm to pivot about the pivot point between the home or molding position, and a molded part release position disposed from the home or molding position during thermoforming apparatus operation.

During the thermoforming process, a sheet of thermoformable material, preferably thermoformable plastic, is pressed or sucked by vacuum into a three-dimensionally contoured cavity of a mold of a thermoforming apparatus thereby pressing or sucking the sheet against a portion of the base and the flipper arm. During thermoforming, the flipper arm is disposed in its home or molding position projecting into the cavity of the mold so a portion of the thermoformable material being drawn into the mold cavity by vacuum is urged against the flipper arm thereby conforming it to a three-dimensional shape of the flipper arm. This results in the formation of a substantially complementarily three-dimensionally contoured finger or another undercut shape or configuration in a portion of the package. Once the thermoforming process is completed, the flipper arm is pivoted relative to the base away from the home or molding position, which allows the package to be disengaged from the flipper assembly without damaging the package about the finger and/or undercut. The flipper arm is pivoted by the portion of the thermoformed package in contact therewith away from the home or molding position by demolding of the package from the mold.

For instance, the flipper arm can be pivoted between a first position, preferably the home or molding position, where the flipper arm is substantially perpendicular to the height of the base and a second position, preferably a molded part release facilitating position during demolding, where the flipper arm is substantially parallel to the height of the base. The flipper arm can be moved from the first position to the second position after the thermoforming process and then from the second position to the first position by the spring after the package has been disengaged from the flipper arm. To effectuate the pivoting action of the flipper arm, a first pin can extend through a portion of the base and the flipper arm such that the flipper arm is pivoted about the first pin when the package is disengaged form the flipper arm. Additionally, a second pin can extend through a portion of the base and a third pin can extend through a portion of the flipper arm. The second pin can extend through the first end of the spring and the third pin can extend through the second end of the spring. Alternatively, another mechanical biasing element can be used that mechanically couples the flipper arm to the base in a manner that automatically returns the flipper arm from the second position to the first position after the package is disengaged from the flipper arm during demolding of the package. Further still, the flipper assembly can include a front side having at least one ridge. When the package is thermoformed, the sheet of plastic can be pressed against the at least one ridge producing a finger or undercut substantially conforming to sheet the three-dimensional shape of the flipper assembly, including the at least one ridge, to impart added rigidity to the package.

In one aspect, the present invention is directed to a flipper assembly and method of making a flipper assembly where the pivot point and center of gravity are configured to minimize the magnitude of the force required to return the flipper arm back to the home or molding position after it has been displaced away therefrom to or towards a molded part release position. More specifically, the center of gravity of the flipper arm may be located so as to minimize the vector force required to return the flipper arm to the home or molded position. This can be achieved, for instance, by locating the center of gravity in close proximity to the pivot point of the flipper arm. In another aspect, the present invention is directed to a flipper assembly and method of making a flipper assembly configured to optimize placement of the pivot point and center of gravity of the flipper arm based on at least one of the position and orientation of the flipper assembly and/or flipper arm in the mold cavity.

In yet another aspect, the spring may be mounted to the base and the flipper arm in such a way that the spring stretches and contracts in a linear fashion. The combination of the linear movement of the spring and the location of the center of gravity of the flipper arm help to minimize the amount of force required to return the flipper arm to the home or molded position. Further still, in another aspect of the invention, the flipper arm can be specifically located to utilize gravitational forces to further help return the flipper arm to the home or molded position.

The present invention also is directed to an undercut-molding flipper assembly having a preferred form of a modular “plug and play” cartridge that includes a cartridge base that carries a flipper arm with a three-dimensionally contoured molded feature forming surface, e.g., nose, which is pivotable between a molding position, e.g., operating position, and a molded component release facilitating position disposed distal from the molding position. The flipper arm is pivotally mounted to the base by a pivot with a center of gravity, Cg, of the flipper arm disposed forwardly of the pivot such that gravity acting on the flipper arm, when the flipper arm is disposed in a molded component release facilitating position, produces a return force that returns or facilitates return of the flipper arm to the molding position.

The flipper assembly can have and preferably includes a flipper arm return biasing element that more preferably is an elongate coil spring captured between the cartridge base and flipper arm in tension to facilitate return of the flipper arm to the molding or operating position after being pivoted during part removal or demolding away from the molding or operating position and toward a molded component release position.

The flipper assembly is configured so the flipper arm is pivotably mounted by a pivot that enables pivoting of the flipper arm during molding and demolding between the molding and molded component release positions with the flipper arm having a center of gravity located forwardly relative to the pivot to facilitate return of the flipper arm to the molding or operating position by gravity acting on the flipper arm producing supplemental return force that assists the return force of the return spring.

Various other features, advantages, and objects of the present invention will be made apparent from the following detailed description and any appended drawings.

### DRAWING DESCRIPTION

One or more preferred exemplary embodiments of the invention are illustrated in the accompanying drawings in which like reference numerals represent like parts throughout and in which:

FIG. 1 is a top front perspective view of a preferred embodiment of a pivotable flipper assembly constructed in accordance with the present invention;

FIG. 2 is a cross sectional view of the pivotable flipper assembly of FIG. 1 taken through line 2-2 where a flipper arm is in a first position;

FIG. 3 is a side elevation view of the pivotable flipper assembly of FIGS. 1 and 2 where the flipper arm is pivoted to a second position;

FIG. 4 is an exploded top front perspective view of the pivotable flipper assembly of FIGS. 1-3;

FIG. 5 is a top plan view of another embodiment of the pivotable flipper assembly;

FIG. 6 is a bottom perspective view of a base associated with a preferred embodiment of the pivotable flipper assembly depicted in FIGS. 1-5;

FIG. 7 is a side elevation view of the pivotable flipper assembly of FIG. 5;

FIG. 8 is a top plan view of another embodiment of the pivotable flipper assembly illustrating another embodiment of a flipper arm having a different size or shape;

FIG. 9 is a side elevation view of the pivotable flipper assembly of FIG. 8;

FIG. 10 is a top plan view of yet another embodiment of the pivotable flipper assembly illustrating a further preferred embodiment of a flipper arm having yet another three-dimensional contour, shape and/or size;

FIG. 11 is a side elevation view of the pivotable flipper assembly of FIG. 10;

FIG. 12 is a top plan view of a further embodiment of the pivotable flipper assembly;

FIG. 13 is a perspective view of a mold having a plurality of pivotable flipper assemblies mounted therein;

FIG. 14 is a top front perspective view of a package formed using a mold and flipper assemblies of FIG. 13; and

FIG. 15 is a top front perspective view of the package of FIG. 14 releasably holding a beam-blade type windshield wiper blade.

Before explaining one or more embodiments of the invention in detail, it is to be understood that the invention is not limited in its application to the details of construction and the arrangement of the components set forth in the following description or illustrated in any appended drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

The present invention is based on the inventors' discovery that prior art undercut forming mechanisms in the form of flipper assemblies not only suffered from overstretching of the return spring leading to premature spring failure and increased part defect rates, but that overstretching of the spring occurred due to non-linear stretching or non-linear deformation of the spring during each thermoforming molding cycle. It was further discovered the cause of the non-linear stretching or non-linear deformation of the return spring was due to part of the spring contacting the pivot pin about which the flipper rotates during thermoformed part removal. As the flipper pivoted about its pivot pin during part removal, the portion of the return spring disposed between the pivot pin and the flipper would stretch or deform excessively thereby plasticly deforming and overstretching that portion reducing the return force the overstretched spring could generate. When too much plastic deformation or overstretching occurred and the return spring force became too low, the flipper would fail to return to its home or molding position thereby producing defectively thermoformed parts until the overstretched return spring was replaced. As depicted in the drawing figures and disclosed in more detail below, a flipper assembly constructed in accordance with the present invention is configured such that the return spring does not contact any part of the pivot pin nor any other part of the flipper assembly during pivoting of the flipper between the home or molding position and a molded part release facilitating position, demolding or part removal position thereby preventing nonlinear elongation and overstretching of the spring.

The present invention is based on the inventors' further discovery that some flipper assembly orientations and flipper configurations resulted in the force of gravity acting on the flipper in a way that opposed or counteracted the return force of the spring enough to prevent the flipper from reliably and repeatably returning to the home or molding position even when the spring was not overstretched enough to require replacement. As further depicted in the drawing figures and disclosed below, a flipper assembly constructed in accordance with this further aspect of the invention is configured so the force of gravity acting on the flipper works in concert with the force of the return spring, including by acting in a similar or same direction as the return spring force, produces a flipper assembly of the invention that more reliably and repeatably travels between the molding and demolding positions, possesses increased return spring life, and which reliably operates in orientations not previously heretofore believed usable.

A flipper assembly constructed in accordance with the present invention advantageously operates more reliably for a longer time, is more versatile, enables deeper, larger and more aggressive undercuts and fingers to be thermoformed, and can be used in orientations and applications where other types of undercut thermoforming devices are not well suited.

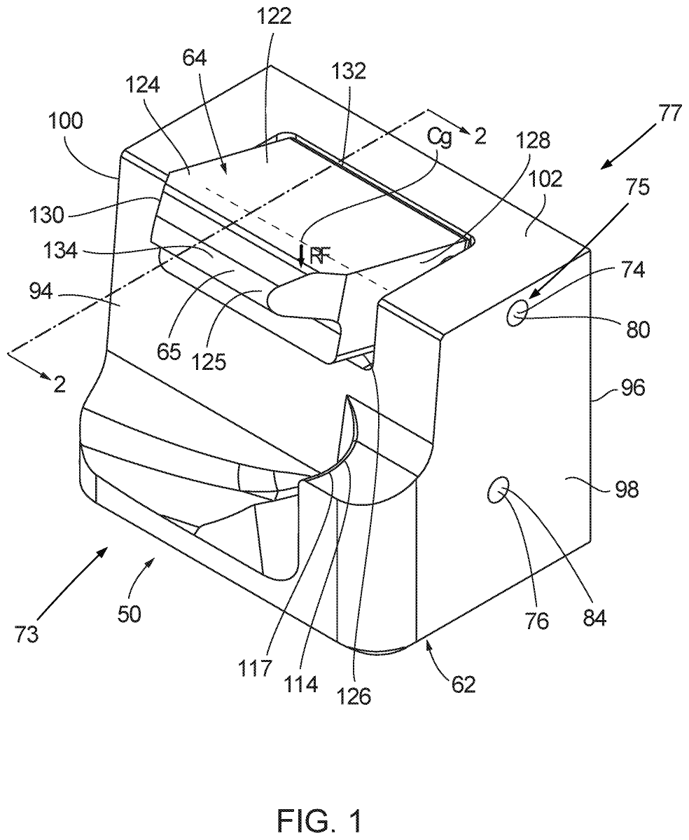

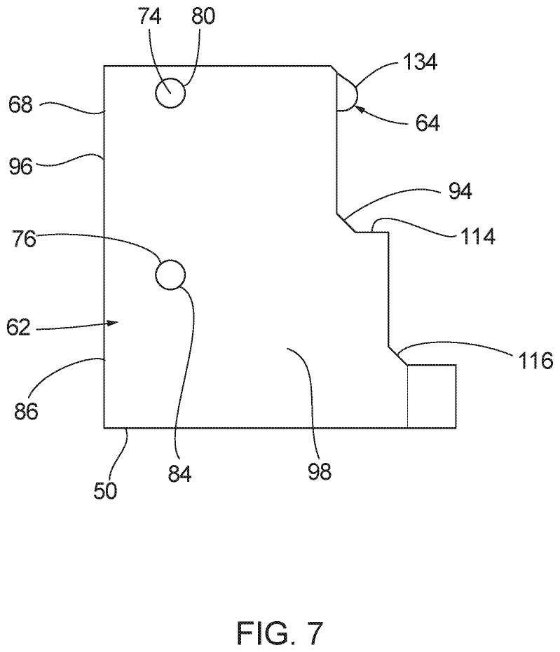

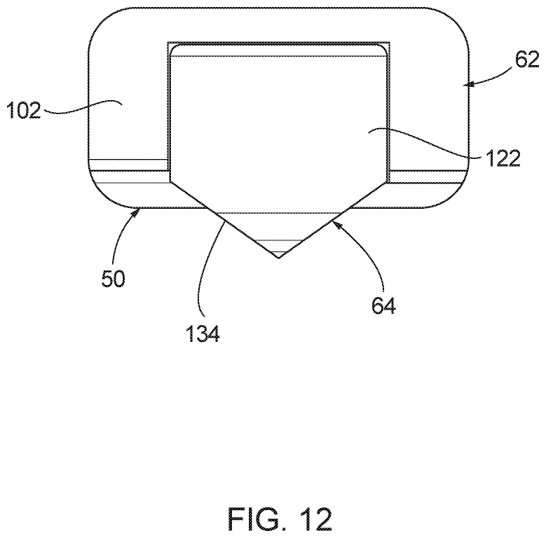

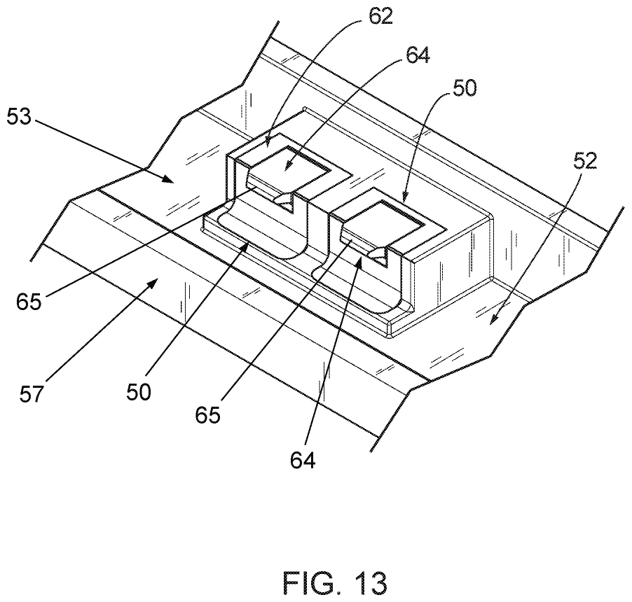

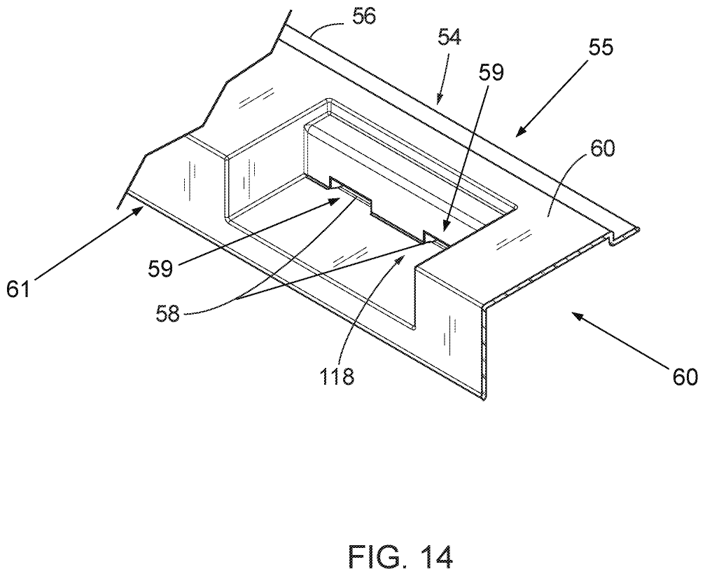

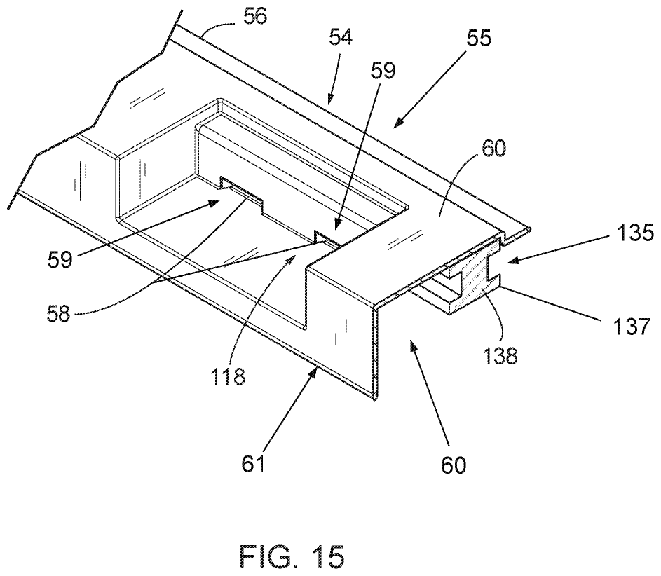

With reference to FIGS. 1-15, the present invention is directed to a flipper assembly 50 for use in a mold 52 of a molding or forming machine 51, such as depicted in FIG. 13, in carrying out a molding or forming process to mold or form a relatively long projection, preferably an elongate or extreme undercut, more preferably a flipper or finger, in a molded or formed component 54 that preferably is a reclosable article-holding package 55, which more preferably is a reclosable wiper blade package 61, such as depicted in FIGS. 14 and 15, during molding or forming of the component 54. With reference to FIG. 13, a plurality of the flipper assemblies 50 of the present invention are removably installed adjacent one another side-by-side in a thermoforming mold 52 of a thermoforming machine 57, e.g., vacuum thermoforming machine, with each flipper assembly 50 configured with a pivotable flipper arm 64 having an outwardly extending three-dimensionally contoured undercut forming surface 65 that projects outwardly into a three-dimensionally contoured cavity 53 of the mold 52 during thermoforming of the molded component 54.

With continued reference to FIGS. 13-15, the undercut forming surface 65 of the flipper arm 64 extends into the mold cavity 53 in the mold 52 and is configured to three-dimensionally thermoform an elongate outwardly projecting undercut 59, preferably in the form of a finger 58, e.g., an elongate article-retaining finger, which projects into an article-holding compartment 60 of the thermoformed molded component 54. FIG. 14 illustrates a three-dimensionally contoured thermoformed molded component 54 that is a portion of a three-dimensionally contoured thermoformed reclosable package 55 that preferably is a three-dimensionally contoured thermoformed wiper blade package 61 after being thermoformed in thermoforming mold 52 and using the plurality of flipper assemblies 50 to respectively thermoform a plurality of side-by-side article-retaining fingers 58 that both project into the article-holding compartment 60 in the package 61 and are configured to releasably retain an article 135 (FIG. 15) therein. FIG. 15 illustrates the molded component 54 of FIG. 14 with an article 135 releasably retained in a three-dimensionally contoured article-holding compartment 60 thermoformed therein that is a wiper blade 138, preferably a pre-curved or pre-tensioned beam-type wiper blade or beam blade, which each one of the thermoformed fingers 58 engaged with an elongate beam 137 of the blade 138 to help releasably hold the blade 138 in the package 61 in the compartment 60 with the beam 137 and blade 138 releasably retained by the fingers 58 in at least a partially straightened condition. In the preferred thermoformed reclosable beam-blade wiper blade package 61 depicted in FIG. 15 with article-engaging fingers 58 thermoformed with flipper assemblies 50 of the present invention is configured to engage and releasably retain an elongate beam 137 of a beam-type wiper blade 138 in a substantially straightened condition with the beam 137 held substantially straight in the compartment 59 of the package 61. Such a flipper assembly 50 of the present invention is therefore particularly well suited for use in thermoforming reclosable wiper blade packaging, including the wiper blade packages disclosed in commonly owned U.S. Pat. Nos. 10,035,642; 9,567,152; 9,139,347; 8,910,789; 8,613,357; and 8,042,690, the entirety of each of which is hereby expressly incorporated herein by reference.

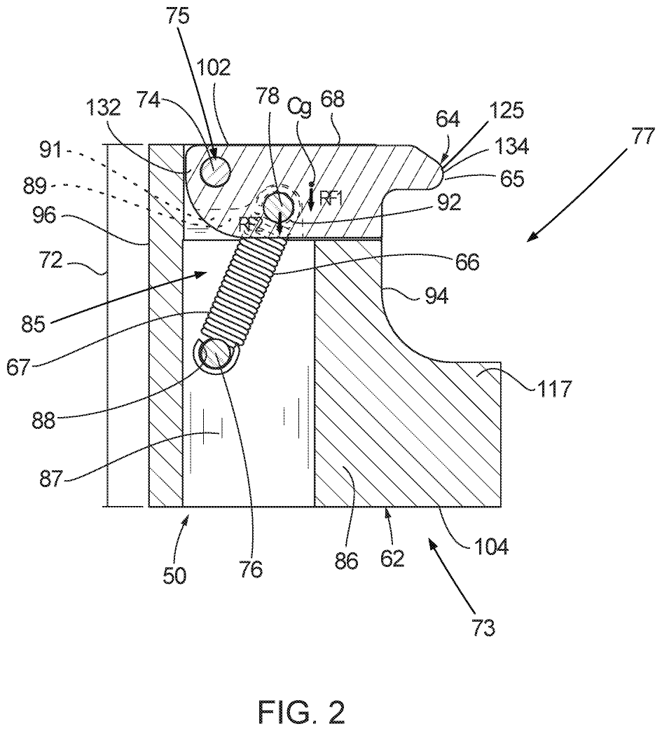

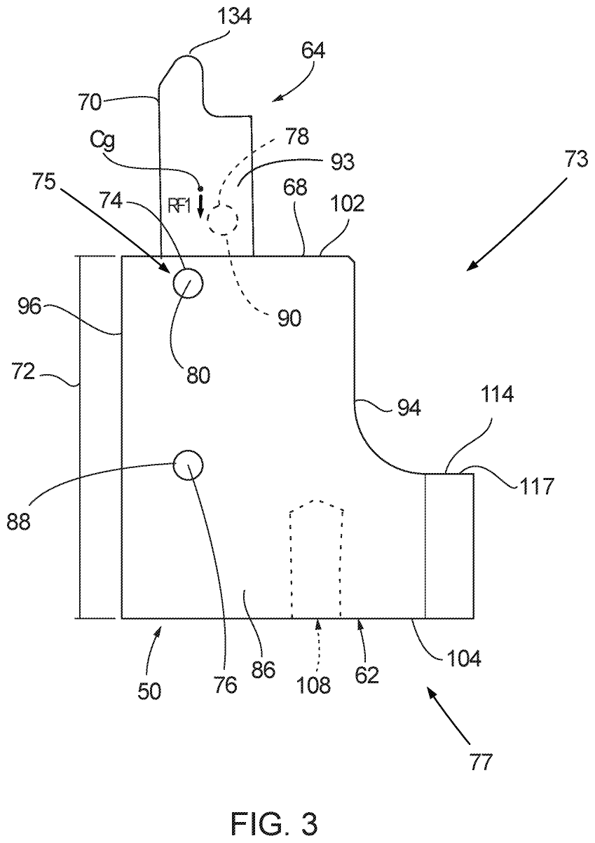

As known to those of ordinary skill in the art, the thermoforming process consists of heating a sheet of material, such as plastic, e.g., polyethylene terap or other resinous material, to a desired temperature before contacting the heated sheet with the mold. For instance, oftentimes a vacuum is applied to the heated sheet to suck the sheet against the mold. Thereafter, material is cooled, and the sheet substantially retains the shape of the mold. During thermoforming of molded component 54, the pivotable flipper arm 64 of a flipper assembly 50 of the present invention is configured to pivots relative to the mold 52 between a molding or thermoforming position, shown in FIG. 2, where the flipper arm 64 is disposed in the mold cavity 53 during thermoforming, and a molded component release facilitating position, e.g., demolding position, such as depicted FIG. 3, where the flipper arm 64 is pivotably disposed outwardly away from the mold cavity 53 during demolding or removal of the finished molded component 54 from the mold 52.

With reference once again to FIGS. 1-7, a flipper assembly 50 constructed in accordance with the present invention is specifically configured to allow for thermoformed components 54, such as reclosable wiper blade packages 61, which have extreme undercuts 56 and/or fingers 58 thermoformed therein that extend into an article holding cavity 60 of the thermoformed component 54, e.g., wiper blade package 61, being thermoformed. While these extreme undercuts 56 and/or fingers 58, can be configured to improve the durability and strength of thermoformed components 54, particularly wiper blade packages 61, which are relatively thin-walled, it can be difficult to remove each component 54, e.g., package 61, from the mold 52 once the thermoforming process has been completed and the component 54 has been cooled without damaging or even destroying the component 54. A flipper assembly 50 constructed in accordance with the present invention is specifically configured to allow the thermoformed component 54, e.g., package 61, to be removed from the mold 52 once thermoforming is done, while minimizing the risk that the component 54 is damaged by the mold 52 and/or the flipper assembly 50.

The flipper assembly 50 includes a mounting base 62 removably fixed to part of the mold 52, a flipper arm 64 operatively connected to the base 62 and configured to move relative to the base 62 and the mold 52 during thermoforming machine operation, and a pivot 75 operatively connecting the flipper arm 64 to the base 62 and configured to enable the flipper arm 64 to move relative to the base 62 and mold 52 by pivoting or rotating about the pivot 75. The flipper arm 64 is pivotably connected to the base 62 by the pivot 75 and configured to pivot relative to the base 62 and mold 52 during thermoforming machine operation between a first or molding position, such as shown in FIG. 2, where the outwardly projecting undercut forming surface 65 forms an undercut or preferably a finger in the thermoformed part 54, e.g. wiper blade package 61, and a second or demolding position, such as depicted in FIG. 3, during removal of the same part 54, e.g., package 61, from the mold 52.

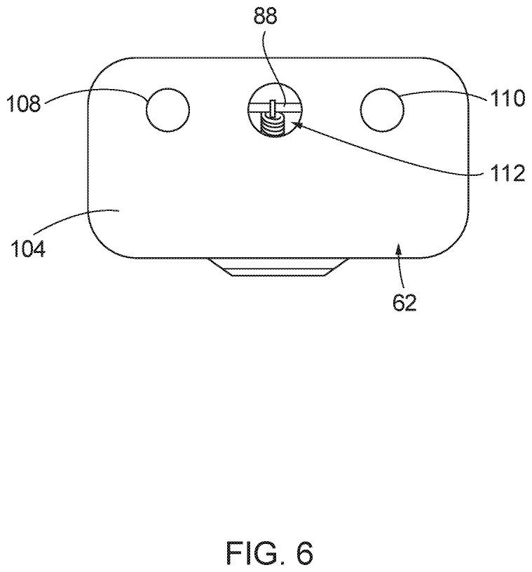

The base 62 is configured for removable mounting to part of the mold 52 and configured for removable attachment of one of a plurality of differently shaped or sized flipper arms 64 having one of a plurality of different lengths, widths, thicknesses, or outer undercut forming surfaces 65. With reference to FIG. 6, the base 62 has a bottom 104 with a plurality of threaded mounting openings 108, 110 formed therein for removable mounting to the mold 52 using threaded fasteners (not shown), such as a plurality of threaded bolts (not shown). The base 62, flipper arm 64, and rest of the components that form a flipper assembly 50 constructed in accordance with the present invention produce a “plug and play” modular flipper cartridge 73 or flipper assembly cartridge module 77 that can be just as easily be attached to a mold 52 as be removed from the mold 52.

As previously indicated, during thermoforming machine operation, the flipper arm 64 rotates relative to base 62 and mold 52 by rotating about the pivot 75 between the first or molding position, shown in FIG. 2, and a second, part removal or demolding position, such as depicted in FIG. 3, where the flipper arm 64 is disposed in a rotational position distal from the first or molding position. In the flipper assembly 50 shown in FIGS. 2 and 3, the flipper arm 64 is rotated upwardly counterclockwise from the generally horizontal first or molding position towards a second, part removal, or molded component demolding position by the thermoformed component 54, preferably wiper blade package 61, being pulled free of the mold 52 during demolding. As is shown in FIGS. 2 and 3, when disposed in the second, part removal or demolding position, the flipper arm 64 is oriented at an oblique angle and can be oriented at a right angle from or relative to the flipper arm 64, when disposed in the first or part molding position.

The base 62 of the flipper assembly 50 shown in FIGS. 1-7 is generally vertically oriented when mounted in the mold 52 and preferably larger than the flipper arm 64. The flipper arm 64 is generally horizontally oriented when disposed in the first or molding position, and the flipper arm 64 is disposed at an angle relative to horizontal when disposed in a second, molded component removal, or part demolding position. The flipper arm 64 is elongate and has a flipper arm body 122 from which a narrowed or necked down outwardly projecting three-dimensionally contoured undercut or finger forming tongue 134 outwardly extends which has an arcuate or rounded nose 125 at its free end collectively defining a three-dimensionally contoured undercut forming outer surface 65 around which the undercut or finger of the component 54, preferably wiper blade package 61, is formed during thermoforming of the component 54, preferably package 61, in the mold 52. The flipper arm 64 is configured with a center of gravity, Cg, disposed outwardly of the pivot 75 such that the force of gravity acting on the weight or mass of the flipper arm 64 generates, produces or provides a flipper arm return force, RF1, in a direction opposing rotation of the flipper arm 64 away from the first or molding position shown in FIG. 2. When the flipper arm 64 is disposed in its generally horizontal molding position, such as the molding position shown in FIG. 2, the force of gravity acting on the center of gravity, Cg, of the flipper arm 64 generates, produces or provides a generally downwardly acting gravity-actuated flipper arm return force, RF1, such as also shown in FIG. 2, which holds or helps hold the flipper arm 64 in the molding position during thermoforming of a molded component 54, preferably package 61, in the mold 52. When the molded component 54, e.g., package 61, is released and being pulled out of the mold 52 during demolding, separation of the molded component 54, e.g., package 61, from the mold 52 rotates the flipper arm 64 away from the molding position towards a part demolding position, such as depicted in FIG. 3, disposed distal to or away from the molding position. When the molded component 54, e.g., package 61, completely disengages or separates from the flipper arm 64, the force of gravity acting on the center of gravity, Cg, of the flipper arm 64 generates, produces or provides a generally downwardly acting gravity-actuated flipper arm return force, RF1, that returns or helps return the flipper arm 64 from a demolding position, e.g., the generally vertical demolding position depicted in FIG. 3, back to the generally horizontal molding position shown in FIG. 2. When the flipper arm 64 is disposed in the molding position, the undercut or finger forming surface 65, including elongate nose 134, extends or projects outwardly from the base 62 into the cavity 53 of the thermoforming mold 52 ready for thermoforming another component 54, preferably wiper blade package 61.

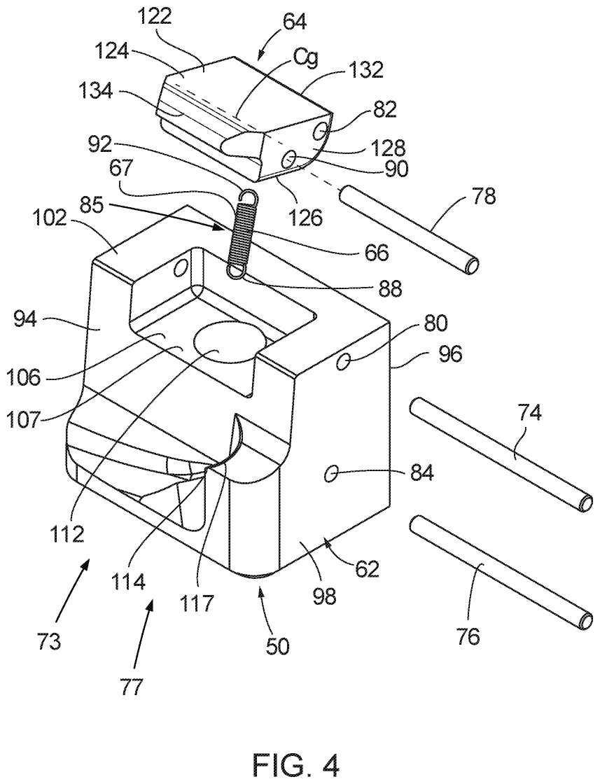

While a flipper assembly 50 constructed in accordance with the present invention can be composed of the base 62, flipper arm 64, and a pivot 75 formed of an elongate generally cylindrical pivot pin 78 received in flipper arm pivot pin receiving bores 80 and 82 formed respectively in the base 62 and flipper arm 64, the flipper arm 64 can be operatively connected to the base 50 by a flipper arm return biasing element 85, such as a spring 66, which is configured to provide a biasing element-actuated flipper arm return force, RF2, that preferably is a spring-actuated flipper arm return force, RF2, in lieu of or in addition to gravity-actuated the return force, RF1, provided by gravity acting on the flipper arm center of gravity, Cg.

Where a spring 66 is used to provide biasing element flipper arm return force, RF2, the spring 66 preferably disposed in operable cooperation with both the flipper arm 64 and base 62 and configured to impart or exert a spring-actuated return force, RF2, on the flipper arm 64 that causes the flipper arm 64 to pivot or rotate about pivot 75 from a demolding position towards its molding position. With reference to FIGS. 2 and 4, a preferred flipper assembly 50 constructed in accordance with the present invention employs an elongate, generally cylindrical coil spring 67 having one end operatively connected by a first spring anchor pin 76 to the base 62 and the other end operatively connected a second spring anchor pin 78 to the flipper arm 64 with the coil spring 67 captured in tension therebetween. The spring 67 is housed within the flipper assembly 50 having one section of the spring 67 extending from the end attached to spring anchor pin 76 received in an elongate generally cylindrical first spring conduit 87 formed in the base 62 and another section of the spring 67 extending from the end attached to spring anchor pin 78 received in a second spring conduit 89 that preferably is a generally U-shaped channel 91 formed in between a pair of parallel spaced apart elongate lobes 93 of the flipper arm 64 (only one lobe 93 of which is shown). As the flipper arm 64 is rotated relative to the base 62 and mold 52 away from the molding position towards a demolding position disposed from the molding position, stretching of the coil spring 67 generates a spring-actuated flipper arm return force, RF2, on the flipper arm 64 that opposes additional rotation away from the molding position. When the molded component 54, e.g., wiper blade package 61, separates or disengages from the flipper arm 64 during demolding, the spring-actuated element return force, RF2, urges the flipper arm 64 to rotate back to the molding position to ready the flipper arm 64 for another thermoforming cycle.

Where the molding position of the flipper arm 64 is generally horizontal and a return force, RF2, provided by a biasing element 85, such as spring 66, a flipper assembly 50 of the present invention is a gravity assisted spring actuated flipper assembly 50 because gravity-actuated flipper arm return force, RF1, provided by gravity acting on the center of gravity, Cg, of the flipper arm 64 assists the biasing element actuated flipper arm return force, RF2, provided by biasing element 85, preferably spring 66, more preferably coil spring 67, in rotating or pivoting the flipper arm 64 away from a demolding position back towards the molding position thereby readying the flipper arm 64 and mold 52 to thermoform another component 54, preferably wiper blade package 61. Where the flipper assembly 50 is of gravity return assisted construction, the center of gravity, Cg, of the flipper arm 64 preferably is disposed in a longitudinal or lengthwise direction of the flipper arm 64 forwardly of both the pivot 75, e.g., pivot pin 74, and the flipper arm spring anchor pin 78, when the flipper arm 64 is disposed in a molding position that is generally horizontal, like the generally horizontal molding position shown in FIG. 2. Where the molding position of the flipper arm 64 is a generally horizontal molding position, such as depicted in FIG. 2, the center of gravity, Cg, of the flipper arm preferably is disposed in a height-wise direction of the flipper arm 64 between the pivot 75, e.g., pivot pin 74, and the flipper arm spring anchor pin 78. The center of gravity, Cg, preferably is generally centrally located in a widthwise direction relative to the flipper arm, such as is depicted in FIG. 1.

As previously discussed, the flipper assembly 50 preferably is a spring-actuated and gravity assisted flipper assembly 50 but can be configured or implemented using only gravity as the actuator that provides the flipper arm return force, e.g., RF1. Where actuated only using gravity, flipper assembly 50 would be constructed or configured without any biasing element 85, spring 66, coil spring 67, or spring anchor pins 76, 78, relying only on gravity acting on the mass of the flipper arm 64, more specifically acting on the center of gravity, Cg, of the flipper arm to generator, produce or provide gravity-actuated flipper arm return force, RF1, that pivots the flipper arm 64 back to the molding position after demolding is completed.

However, the flipper arm 64 of flipper assembly 50 may be actuated using a variety of different actuators, such as gravity-actuated, magnetic field actuated, by use of a biasing element actuator that is an elastomeric actuator, a spring actuator that is a torsion spring, or by use of another type of actuator configured to operably cooperate with the base 62 and flipper arm 64 to provide a flipper arm return force that rotates or pivots the flipper arm 64 from a demolding position back to the molding position. If desired, the flipper arm 64 of a flipper assembly 50 constructed in accordance with the present invention may be actuated using a plurality of actuators each contributing or providing a flipper arm return force with combinations contemplated as being within the scope of the present invention including gravity actuated and biasing element actuated, gravity actuated and spring actuated, and/or gravity actuated and magnet actuated with gravity being an actuator acting on the center of gravity, Cg, of the flipper arm to provide gravity actuated flipper arm return force, RF1, as discussed above. As previously discussed, a preferred embodiment of a flipper assembly 50 constructed in accordance with the present invention is a biasing element actuated, preferably spring actuated, and gravity assisted flipper assembly 50 of the invention that employs gravity as a flipper arm return assisting actuator that acts on the center of gravity, Cg, of the flipper arm to generate a gravity-actuated or gravity-assisted flipper arm return force, RF1, that assists the biasing element, preferably spring actuated, flipper arm return force, RF2, provided by biasing element 85, preferably spring 66, more preferably coil spring 67, in returning flipper arm 64 to the generally horizontal molding position shown in FIG. 2.

With continued reference to FIGS. 1-7, the flipper assembly 50 includes a base 62, a flipper arm 64, and a resilient mechanically operable flipper arm biasing arrangement 65 operatively connected to the flipper arm 64 and base 62 that preferably is or includes a spring 66. During operation, the flipper arm 64 is movable relative to the base 62 and the mold in which the base 62 is fixed between a first position that is a thermoformed part molding position, like that depicted in FIG. 2, and a second position that is a second position that is a part demolding position, like that depicted in FIG. 3, which is disposed away from the first or molding position.

The flipper arm biasing arrangement 65 is disposed in operable cooperation with the flipper arm 64 and base 62 preferably operatively cooperating with the flipper arm 64 and base 62 to oppose rotation or oppose movement of the flipper arm 64 away from the molding position when being displaced towards a demolding position disposed from the molding position during removal of the thermoformed part, e.g., thermoformed component 54, from the mold of the thermoforming machine. In a preferred embodiment, the flipper arm biasing element arrangement 65 is a spring 66, preferably coil spring 67, which operatively extends between the flipper arm 64 and the base 62, preferably operatively connecting the flipper arm 64 and base 62, and more preferably extending between or linking the flipper arm 64 and base 62. As previously discussed, the biasing element arrangement 85 is a lone biasing element captured in tension whose stretching during rotation of the flipper arm 64 away from the molding position, such as the molding position shown in FIG. 2, and towards a demolding position, such as the demolding position shown in FIG. 3, generates a flipper arm return force, RF2, that opposes rotation towards the demolding position and urges the flipper arm 64 towards the molding position.

For instance, as shown in FIGS. 2, 7, 9, and 11 the flipper arm 64 is in a first position 68. The first position 68, e.g., forming or molding position, is where the flipper arm 64 naturally rests prior to and during the thermoforming process. In the first position 68, the flipper arm 64 extends substantially perpendicular relative to the lengthwise direction or height 72, e.g., height-wise direction, of the base 62. The flipper arm 64 is shown in the second position 70, e.g., a molded component demolding facilitating position, in FIG. 3 where the flipper arm 64 extends substantially parallel to the lengthwise direction or height 72, e.g., height-wise direction, of the base 62. The flipper arm 64 moves from the first position 68 to the second position 70 while the thermoformed component 54 is being removed from the mold 52. Once the flipper arm 64 has been moved to the second position 70 and the thermoformed component 54 has been disengaged from the flipper arm 64, the spring 66 causes the flipper arm 64 to automatically be returned to the first position 68, e.g., thermoforming position.

Additionally, the center of gravity Cg of the flipper arm 64 minimizes vector forces required to return the flipper arm 64 to the first position, which in turn allows the flipper arm 64 to more easily return to this position with minimal force by the spring 66. More specifically, the location of a pivot pin 74 of the flipper arm 64, which will be further described below, is located about the flipper arm 64 at a location that results in a center of gravity Cg that is configured to minimize the magnitude of force that is required to return the flipper arm 64 from the second position 70 to the first position 68. Stated differently, the center of gravity Cg may further be located to minimize the vector force required to return the flipper arm 62 to the first position 68. As shown in FIGS. 1, 2, and 4, the center of gravity Cg is located in close proximity to the pivot pin 74 of the flipper arm 64. Placement of the pivot pin 74 and the center of gravity Cg of the flipper arm 64 may be optimized based on the position and orientation of the flipper arm 64 relative to the base 62. Further still, the position and orientation of the flipper arm 64 and/or the base 62 may be selected to utilize gravitational forces to further help return the flipper arm 64 to the first position 68. The center of gravity Cg and the spring 66 are force vectors that impact movement of the flipper arm 64, and more specifically movement of the flipper arm 64 from the second position 70 to the first position 68. The spring 66 will always serve as a return force vector. In contrast, the center of gravity Cg may be a return force vector, or it can be a force vector that opposes the return of the flipper arm depending on its location and orientation.

The spring 66 also retains the flipper arm 64 in the first position 68, e.g., the thermoforming position, during thermoforming of the component 54 in the three-dimensionally recessed mold cavity of the mold 52. The flipper assembly 50 of the present invention is configured with a spring 66 in tension that movably, e.g., rotatively, operatively connects or operably couples the flipper arm 64 to the base 62 having a spring constant sufficient to permit the flipper arm 64 to move, preferably rotate, relative to the base 62 between the first position, the thermoforming position, during component molding, and the second position, the demolding facilitating position, during molded component removal. The flipper assembly 50 is configured with a spring 66 having a sufficient spring constant, spring tension, or spring force to resiliently retain the flipper arm 64 in the first position, the thermoforming position, and also resiliently urge the flipper arm 64 back towards the first position, the thermoforming position, after the flipper arm 64 is displaced by component 54 during removal of the formed or finished thermoformed component 54 from the cavity of the mold 52. The flipper assembly 50 also is configured with the spring 66 having a sufficient spring constant, spring tension, or spring force to allow a portion of the finished thermoformed component 54 in contact with part of the flipper arm 64 to displace the flipper arm 64, preferably by rotating the flipper arm 64 relative to the base 62 and mold 52 toward the second position, the demolding position, by separation of the finished thermoformed component 54 away from the mold 52 during demolding of the component 54 after thermoforming of the component 54 is finished. The flipper assembly 50 is further configured with the spring 66 having a sufficient spring constant, spring tension or spring force to return the flipper arm 64 back to the first position, the thermoforming position, when the portion of the component 54 in contact with the flipper arm 64 disengages or separates from the flipper arm 64 during demolding of the finished package 54. As shown, the flipper assembly 50 is preferably configured such that the spring 66 extends in a linear fashion only while the flipper arm 64 is moved between the first and second positions. In doing so, the spring 66 can functionally operate for a much longer period of time prior to failure in comparison to springs that are extended in non-linear fashion.

The flipper assembly 50 can and preferably does include a plurality of pins that helps to enable the use of the flipper assembly 50 and to secure the spring 66 in place relative to the base 62 and the flipper arm 64. To enable the flipper arm 64 to be moved away from the first position toward the second position by a portion of the molded component, preferably thermoformed component 54, during separation of the molded component, preferably packaging 54, from the mold 52 during demolding, the flipper arm 64 is attached to the base 62 by a pivot that preferably is an elongate pivot pin 74 that extends through at least part of the flipper arm 64 into a portion of the base 62 disposed along one side and preferably disposed along both sides of the flipper arm 64. For instance, the illustrated embodiment includes a first pin 74 that provides a flipper arm pivot enabling pivoting of the flipper arm 64 relative to the base 62 and mold 52 between the first and second positions during cycling of the thermoforming mold. The first pin 74 is a flipper arm pivot that extends through openings 80 formed in base 62, as well as openings 82 formed in the flipper arm 64. The flipper arm 64 is pivotable relative to the base 62 about the first pin 74, such that the flipper arm 64 pivots from the first position 68 to the second position 70 relative to the first pin 74.

The illustrated embodiment may also include a second pin 76, and a third pin 78. The second pin 76 can and preferably does extend through an opening 84 formed in a lower portion 86 of the base 62. The second pin 76 preferably is a first spring anchor that is configured to also extend through a first end 88 of the spring 66 thereby anchoring the first end 88 of the spring 66 to the base 62. The first end 88 is shown in FIGS. 2 and 4. Because the second pin 76 is not moveable relative to the base 62, the first end 88 of the spring 66 also remains in place such that the second pin 76 anchors the spring 66 to the base 62.

Similarly, the third pin 78 extends through an opening 90 formed in the flipper arm 64, as well as a second end 92 of the spring 66 and functions as a second spring anchor that anchors the opposite end or second end 92 of the spring 66 to the flipper arm 64. As can be seen in FIG. 2 the first pin 74 is vertically offset from the second pin 76. This offset of the first pin 74 and the second pin 76 causes the spring 66 to extend and retract primarily, and more preferably only in a linear direction. Since the flipper arm 64 is pivotable relative to the base 62, the second end 92 of the spring 66 is also movable relative to the base 62. Because the first end 88 of the spring 66 is secured to the base 62 relative to the second pin 76, and the second end 92 of the spring 66 is secured to the flipper arm 64 relative to the third pin 78, but is pivotable relative to the base 62, the spring 66 is extended from a resting position as the flipper arm 64 is rotated from the first position 68 to the second position 70 to an extended position. Again, this movement is preferably linear to minimize damage to the spring 66. While the spring 66 allows this movement to occur, it will automatically bias back toward the resting position where the spring 66 is less extended. This is especially true given that the center of gravity of the flipper arm 64 allows the flipper arm 64 to be returned to the first position with minimal force. When the flipper arm 64 is released, the spring 66 automatically retracts, preferably in a linear fashion, which causes the flipper arm 64 to rotate back from the second position 70 to the first position 68. In this way, the flipper arm 64 only rotates to the second position 70 when the thermoformed component 54 is removed from the flipper assembly 50. As the thermoformed component 54 is disengaged first from the mold 52 and then from the flipper arm 64 during demolding, the flipper arm 64 automatically moves back to the first position due to the strength of the spring 66, as well as its connection to the second pin 76 and third pin 78, and base 62 and flipper arm 64 by extension.

As best shown in FIGS. 1-4, the flipper arm pivot is an elongate pivot pin 74 that extends completely through a longitudinal extent of the flipper arm 64 and into at least a portion of the base 62 disposed along either side or end of the flipper arm 64 defining a longitudinal pivot axis about which the flipper arm 64 pivots. The pivot, preferably pivot pin 74, preferably is offset to one side of a longitudinal center or longitudinal centerline of the flipper arm 64 so that the pivot, preferably pivot pin 74, defines a moment arm about which the flipper arm 64 pivots during mold cycling or thermoforming cycling. By offsetting the pivot, preferably pivot pin 74, relative to a longitudinal center or longitudinal centerline of the flipper arm 64, gravity can act as a downward force on a portion of the flipper arm 64 opposite the pivot, preferably pivot pin 74, producing a moment about the pivot, preferably pivot pin 74, which can act in concert with the spring 66 and help return the flipper arm 64 from the second or demolding position to the first or thermoforming position.

The flipper arm 64 is disposed in a recessed flipper arm seat 107 formed in a top portion of the base 62 in which the flipper arm 64 is received or seats when the flipper arm 64 is disposed in the first or thermoforming position. When received in the flipper arm seat 107, the flipper arm 64 is surrounded on three sides by an upraised portion of the base 62 that forms or defines the top of the base 62.

When seated in the flipper arm seat 107, the flipper arm 64 is bounded along one longitudinal side of the flipper arm 64 by an upraised elongate rear portion of the top of the base 62 and is bracketed along each end of the flipper arm 64 by respective upraised sides of the top of the base 62. The flipper arm pivot preferably is an elongate pivot pin 74 that extends through the entire longitudinal extent of the flipper arm 64 into both upraised sides of the top of the base 62. The pivot, preferably elongate longitudinally extending pivot pin 74, is offset towards the rear portion of the top of the base 62 such that the pivot pin 74 is disposed between the rear portion of the top of the base 62 and the spring 66.

The result of positioning the pivot, preferably pivot pin 74, between the rear portion of the top of the base 62 and spring 66 is that a spring flipper arm return force is produced that is a moment about the pivot, preferably pivot pin 74, which more readily and efficiently urges the flipper arm 64 to return to the first or thermoforming position where the flipper arm 64 is received in the recessed flipper arm seat formed in the top of the base 62 after being pivoted away from the first or thermoforming position during molded component, preferably thermoformed component 54, demolding. In doing so, the pivot, preferably pivot pin 74, forms a moment arm about which the flipper arm 64 pivots between the first or thermoforming position and the second or demolding position. In doing so, the pivot, preferably pivot pin 74, forms a moment arm about which the flipper arm 64 pivots between the first or thermoforming position and the second or demolding position.

Selective embodiments of the flipper arm 64 and base 62 will now be described. While the figures show various embodiments of the flipper arm and base, it should be known that the specific dimensions and shapes of the flipper arm and base can be varied depending on the desired dimension and shape of the undercut, finger, flipper, notch, or the like in the final thermoformed component. As will be appreciated looking to the resulting thermoformed component shown in FIGS. 14 and 15, the ultimate shape of the undercut, finger, flipper, notch, or the like will directly correlate to the cross-sectional view of the base and flipper arm.

Looking to the figures generally, the base 62 has a front wall 94, a rear wall 96, first and second sidewalls 98, 100, a top side 102, and a bottom side 104. Additionally, a middle side platform 106 can be offset from the top side 102 to form a seat 107. The flipper arm 64 can rest on top of the middle side platform 106 and can be rotated relative to the base 62 upwardly to the second position 70, as described above. The rear wall 96, first and second sidewalls 98, 100, and bottom side 104 are all substantially flat, which allows the base 62 to be secured into the mold 52. Additionally, a plurality of openings can be formed in the bottom side 104, as can be seen in FIG. 6. For instance, first and second threaded openings 108, 110 can be found in opposite ends of the bottom side 104 of the base 62. Various bolts, screws, and the like (not shown) can be used to secure the base 62 to the mold 52. Additionally, an open shaft 112 can be formed from the bottom side 104 up through the middle side platform 106. This allows the spring 66 to be mounted within the open shaft 112, with the first end 88 being secured in place by the second pin 76, and the second end 92 being secured in place by the third pin 78.

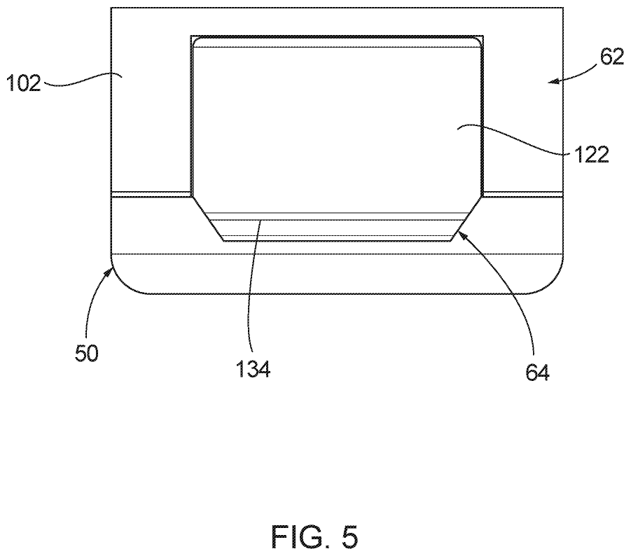

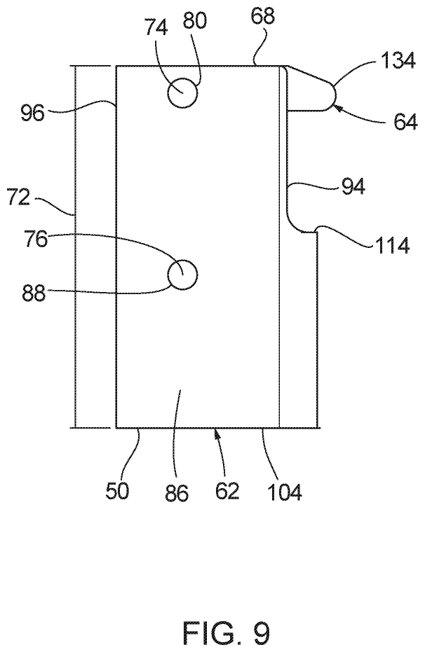

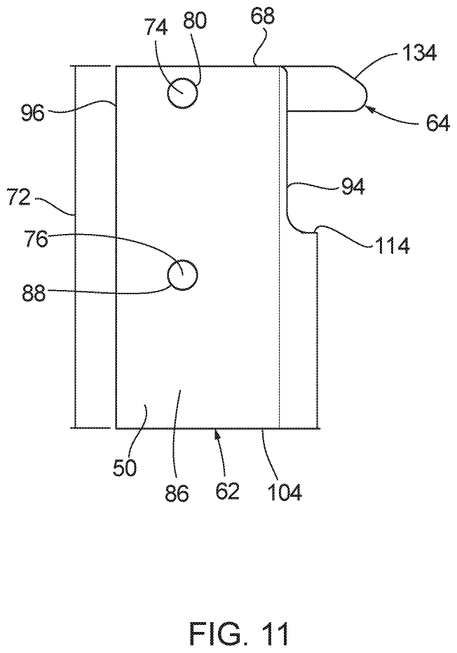

The front wall 94 can have a number of ridges formed therein. For instance, looking to FIGS. 5 and 6, the front wall 94 has a first ridge 114 and a second ridge 116. Of course, the front wall 94 could similarly have additional or fewer ridges, as desired. Again, when the thermoformed component 54 is formed, a heated sheet of plastic is vacuumed against the flipper assembly 50, including the first ridge 114 and the second ridge 116. Therefore, the resulting thermoformed component 54 has notches 118 formed therein that are complimentary in size and shape as the ridges 114, 116. Any of these ridges could have different sizes, curvatures, and shapes based on the desired sizes and shapes of the notches in the thermoformed component. FIGS. 9 and 11 show a slightly different embodiment in which the front wall 94 only has a single ridge 114. Thus, the resulting thermoformed component only has a single notch 118. Additionally, FIGS. 1-4 includes a single ridge 117 that may extend partially across the front wall 94. This ridge 117 may have a curved inner face 119 that slopes downwardly towards the bottom side 104. Further still, the various flipper assemblies mounted to the mold 52 in FIG. 14 have front walls 94 that are substantially straight. Additionally, the front wall 94 could be sloped and it could include various textured features, as desired.

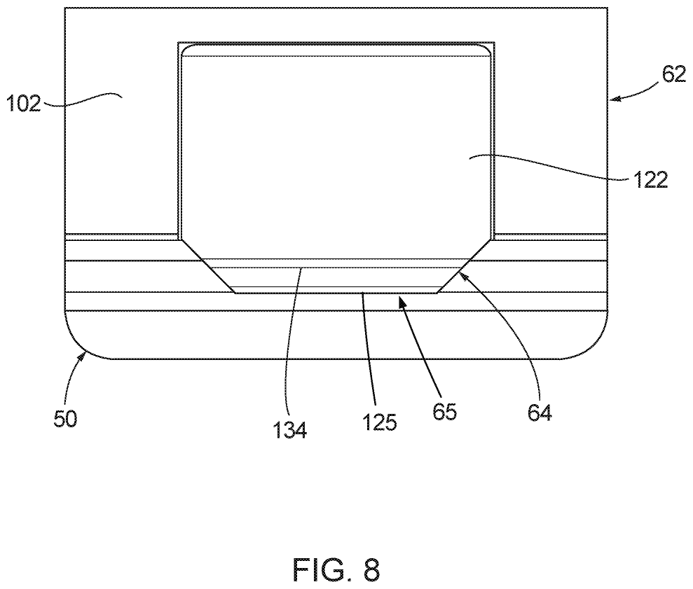

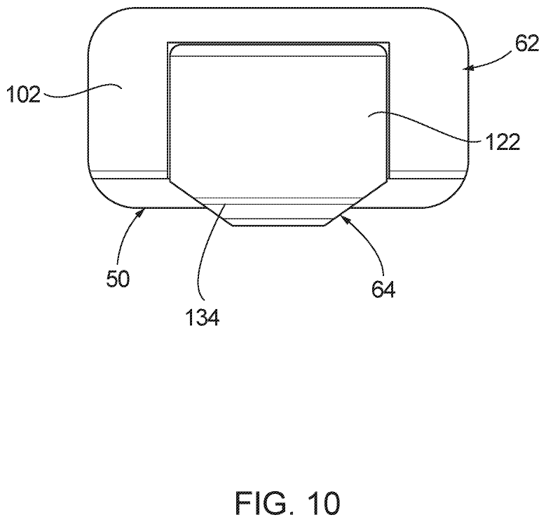

Next, the flipper arm 64 will be further described. The flipper arm 64 includes a base 122 having a top side 124, an underside 126, first and second sidewalls 128, 130, and a backwall 132. The flipper arm 64 also has a tongue 134 with an arcuate nose 135 extending from the front of the base 122. As shown, the tongue 134 tapers downwardly from the top side 124, upwardly from the underside 126, and inwardly from the first sidewall 128 and the second sidewall 130. As seen in the embodiment in FIGS. 1-5, the tongue 134 can be substantially elongate in shape. Alternatively, as seen in FIGS. 8 and 10, the tongue 134 can be narrower in shape. Further still, as shown in FIG. 6, the tongue 134 can be substantially pointed in shape. Of course, the specific shape of the flipper arm 64 is dependent on the desired shape of the notch that will be formed in the thermoformed component during the thermoforming procedure.

Also, the flipper arm 64 can include a channel 91 formed in the underside 126. As shown, the channel 91 extends from the back wall 132 towards the tongue 134. The channel 91 is located to facilitate the spring 66. As such, the openings 82 extending from the first sidewall 128 to the second sidewall 130 intersects with the channel 91. When the third pin 78 is inserted into the opening 82 at the first sidewall 128, it is then threaded through the second end 92 of the spring 66 and through the opening 82 at the second sidewall 130.

Additionally, a method of thermoforming a sheet into a thermoformed component is provided. This can include initially placing a sheet of material into a mold having a flipper assembly as described above. The sheet of material can be heated to a pliable temperature. Thereafter, a pressure differential can be applied to create a suction of the sheet against the flipper assembly. This causes a three-dimensionally contoured component to be formed against the front wall and the flipper arm with a finger, undercut, and/or notch that is formed when the sheet is pressed against a front edge of the flipper arm. Next, the flipper arm can be rotated from the retracted position to the deployed position to release the thermoformed component from the flipper assembly without distorting the thermoformed component. Thereafter, the flipper arm is rotated to the retracted position by the spring. The cross-sectional profile of the thermoformed component can be substantially the same shape as the cross-sectional profile of the base and flipper arm.

Additionally, a method of assembling the flipper assembly 50 is provided. First, the spring 66 may be inserted through the shaft 112 of the cartridge 62. Next, the pin 76 is inserted through the opening 84 of the base and through the first end 88 of the spring 66. Next, pin 74 is inserted through the opening 80 of the cartridge and into the opening 82 of the flipper arm 64. Thereafter, the spring 66 is stretched to the flipper arm 64 and the spring pin 78 is inserted through the flipper arm 64 and the second end 92 of the spring 66.

As shown, the thermoformed component 54 shown in FIGS. 14 and 15 is configured to hold a wiper blade 138. Due to the specific shape of the thermoformed component 54, the wiper blade 138 is held in a substantially straightened condition to minimize the thermoformed component volume and to maximize retail display package density. However, the flipper assembly 50 could be used to create packages configured to hold any number of different items.

A flipper assembly 50 constructed in accordance with the present invention is configured to form or mold a three-dimensionally contoured feature, such as an outwardly protruding undercut or finger, in or into a component, e.g., reclosable clamshell package 54, being molded, e.g., thermoformed, vacuum formed, or vacuum thermoformed, in a three-dimensionally recessed cavity formed in a mold 52 in which the flipper assembly 50 is disposed with at least part of the flipper arm 64 and/or base 62 helping form the feature in the molded component, e.g., package 54, during molding, e.g., thermoforming, vacuum forming, or vacuum thermoforming, of the component, e.g., package 54, in the mold 52. Such a flipper assembly 50 constructed in accordance with the present invention is further configured so that a portion of the flipper assembly 50, preferably the flipper arm 64, moves relative to the base 62 and the mold 52 during demolding of the molded component, e.g., molded package 54, during removal of the component, e.g., package 54, from the cavity in the mold 52 after molding of the component, e.g., package 54, has been completed.

As depicted in the drawing figures and discussed in more detail herein, the flipper arm 64 is configured to be movable, preferably pivotable, relative to at least the base 62 during component demolding from a molding or forming position, e.g., first position, toward a demolding position, e.g., second position, disposed from the molding or forming position to facilitate demolding of the component, e.g., package 54, from the mold 52. In a preferred embodiment and method, the flipper arm 64 is configured to be movable, preferably pivotable, relative to the base 62 and the mold 52 between the molding or forming position, during which the component, e.g., package 54, is molded in the mold 52, and the demolding or component removal position, where the flipper arm 64 moves substantially in unison with a portion of the molded component, package 54, in contact therewith during component removal from the mold 52 thereby facilitating demolding or removal of the component, e.g., package 54, from the mold 52 after molding of the component, e.g. package 54, is finished. By the flipper arm 64 being moved, preferably being pivoted, relative to the base 62 and mold 52 and substantially in unison with a portion of the molded component, package 54, in contact with the flipper arm 64 during demolding by separation of the molded component, e.g., package 54, from the mold 52, molded component removal from the mold 52 is facilitated by preventing the flipper arm 64 from obstructing molded component removal. By the flipper arm 64 moving, preferably pivoting, relative to the base 62 and mold 52 during demolding, it prevents any portion of the molded component, e.g., package 54, from getting caught or hung up on the flipper arm 64 during removal of the molded component, e.g., package 54, from the mold 52 after molding of the component, e.g., package 54, is completed.

As shown in the drawings and discussed in more detail elsewhere herein, the flipper arm 64 is movably anchored to the base 62 of the flipper assembly 50 by a pivot anchor that more preferably is an elongate pivot pin 74 that extends through a portion of the flipper arm 64 disposed in operable communication with the base 62 in a direction transverse to the flipper arm 64 with at least a portion of the pivot pin 74 extending into a portion of the base 62 on at least one and preferably both sides of the flipper arm 64 defining a transverse flipper arm pivot axis about which the flipper arm 64 pivots when moved between the molding or forming position and the demolding or molded component removal position. In a preferred flipper arm assembly embodiment and method, the flipper arm 64 is disposed in a retracted position when disposed in the molding or forming position, e.g., first position, where at least a portion of the flipper arm 64 is received, preferably nests, in part of the base 62 that preferably is a flipper arm seating recess or pocket 107 formed in an outer or top portion of the base 62 disposed distal to a bottom portion or base of the base 62 that is disposed in contact with, e.g., grounded to, the mold 52. In such a preferred flipper arm assembly embodiment and method, the flipper arm 64 is pivoted during demolding away from the retracted position, e.g., away from the molding or forming position, toward an extended position, e.g., second position, where at least a portion of the flipper arm 64 extends outwardly from and/or outwardly of the top portion of the base 62 when the flipper arm 64 is urged to or toward the demolding or molded component removal position by the molded component, e.g., package 54, being removed from the mold 52. When demolding is finished and the molded component, e.g., package 54, is completely detached from the mold 52, the flipper arm 64 automatically returns to the retracted position thereby disposing the flipper arm 64 in the molding or forming position with the flipper arm 64 preferably received or nested in the recessed flipper arm seat 107 formed in the base 62 readying the flipper arm assembly 50 and the mold 52 to mold or form another component, e.g. package 54.

As also shown in the drawings and discussed in more detail elsewhere herein, the flipper arm 64 is disposed in operative cooperation with a mechanical biasing element that preferably is an elongate coil spring 66 captured in tension that biases or urges the flipper arm 64 to return to the molding or forming position when displaced, e.g., pivoted, toward and/or to the demolding or component removal position during demolding of a finished molded component, e.g., package 54, from the mold 52. As also shown in the drawings and discussed in more detail below, the mechanical biasing element preferably is a coil spring 66 that has one end operatively connected to part of the flipper arm 64 by one spring anchor, which preferably is an elongate pin 78, e.g., first elongate spring anchor pin 78, and has an opposite end operatively connected to part of the base 62 by another spring anchor, which preferably also is an elongate pin 76, e.g., second elongate spring anchor pin 76. In light of the locations of the pins 76, 78 relative to the base 62 and the flipper arm 64, the spring 66 preferably extends and retracts in a primarily, and more preferably in only in a linear fashion. In a preferred embodiment and method, the one end of the spring 66 that is anchored by anchor pin 76 to the base 62 is anchored to ground because the base 62 is grounded to the mold 52 by being immovably mounted to the mold 52, such as by being fixed to the mold 52 by one or more fasteners, e.g., bolts.

During molding of the component, e.g., package 54, preferably by thermoforming, vacuum forming or vacuum thermoforming, the spring 66 retains the flipper arm 64 in its retracted molding or forming position where at least a portion, preferably a substantial portion, of the flipper arm 64 is seated in the recessed flipper arm seat 107 formed in the top or outer portion of the base 62. While the flipper arm assembly 50 can be configured so the entire flipper arm 64 can be retracted into the recessed flipper arm seat 107 in the base 62, the flipper arm 64 and base 62 preferably are configured so that substantially all of the flipper arm 64 is seated within the seat 107 except for an undercut forming nose 134 of the flipper arm 64 located at a free end of the flipper arm 64 that protrudes transversely outwardly beyond or from an adjacent part of the upper base 62. Such an undercut forming nose 134 extends outwardly into the cavity of the mold 52 thereby forming a corresponding complementarily three-dimensionally contoured or shaped finger or undercut in the component, package 54, being molded in the mold 52.

When molding is completed, demolding of the component, package 54, occurs to remove the finished molded component, e.g., finished molded package 54, from the cavity of the mold 52. In separating the finished molded component, e.g., finished molded package 54, from the mold 52 in removing it from the mold cavity, a portion of the finished molded component, e.g., finished molded package 54, in contact with a portion of the flipper arm 64 causes the flipper arm 64 to pivot about pivot pin 74 outwardly away from the mold 52 and mold cavity from the retracted molding or forming position toward the demolding or component removal position where at least the undercut forming nose 134 of the flipper arm 64 extends outwardly from the base 62, preferably until at least the undercut forming nose 134 of the flipper arm 64 upwardly relative to the base 62. As the flipper arm 64 is pivoted toward the extended demolding or molded component removal position by the finished molded component, e.g., finished molded package 54, being pulled away from the mold cavity and mold 52 during demolding, an angle between the portion of the finished molded component, e.g., finished molded package 54, in contact with the flipper arm 64 and the flipper arm 64 reaches a release angle where the finished molded component, e.g. finished molded package 54, disengages from the flipper arm 64 without the flipper arm 64 changing the final shape of the finished molded component, e.g., finished molded package 54. When the finished molded component, e.g., finished molded package 54, completely disengages from the flipper arm 64, the spring 66 biases the flipper arm 64 in a primarily, and more preferably a purely linear fashion, from at or adjacent the extended demolding or component removal position toward the retracted component forming or molding position causing the flipper arm 64 to pivot about pin 74 until the flipper arm 64 is received back in the recessed flipper arm seat 107 formed in the top or outer portion of the base 62. When the flipper arm 64 is seated in the recessed flipper arm seat 107, the flipper arm 64 is once again disposed in the component forming or molding position, thereby readying the flipper arm assembly 50 for another component molding cycle to make another molded component.

A flipper assembly 50 of the present invention is configured to retain the flipper arm 64 in the first position, the thermoforming or molding position, and to return the flipper arm 64 back to the first position when demolding or removal of the molded component, e.g., package 54, is completed. The flipper assembly 50 of the present invention also is configured to allow the flipper arm 64 to be pivoted away from the first position, the thermoforming or molding position, by part of the molded component, e.g., package 54, during separation of the molded component, e.g., package 54, during demolding or removal of the molded component from the mold after molding, e.g., thermoforming, of the molded component is finished. The flipper arm assembly 50 of the present invention is further configured to allow the flipper arm 64 to return to the first position, the thermoforming or molding position, upon complete disengagement of the molded component, e.g., package 54, during demolding of the molded component from the mold 52.

A flipper assembly 50 of the present invention is configured with a spring 66 in tension that mechanically movably, e.g., pivotably, operatively connects or operably couples the flipper arm 64 to the base 62 with the spring 66 having a spring constant sufficient to permit the flipper arm 64 to move, preferably rotate, relative to the base 62 between the first position, the molding or thermoforming position, during package molding or thermoforming, and the second position, the demolding or finished mold component removal position, in a primarily and more preferably solely linear fashion during molded package removal. The flipper assembly 50 is configured with such a spring 66 that has sufficient spring constant, spring tension, or spring force to resiliently retain the flipper arm 64 in the first position, the thermoforming or molding position, and also resiliently urge the flipper arm 64 in a linear fashion back towards the first position, the thermoforming or molding position, after the flipper arm 64 is displaced by package 54 during removal of the formed or finished package 54 from the cavity of the mold 52. The flipper assembly 50 also is configured with such a spring 66 having sufficient spring constant, spring tension, or spring force to allow a portion of the finished package 54 in contact with part of the flipper arm 64 to displace the flipper arm 64, preferably by pivoting the flipper arm 64 relative to the base 62 and mold 52 toward the second position, the demolding position, by the finished package 54 separating away from the mold 52 during demolding of the package 54 after thermoforming of the package 54 is finished. The flipper assembly 50 is further configured with such a spring 66 having sufficient spring constant, spring tension or spring force to thereafter return the flipper arm 64 in a linear fashion back to the first position, the thermoforming or molding position, when the portion of the package 54 in contact with the flipper arm 64 disengages or separates from the flipper arm 64 during demolding of the finished package 54.

Understandably, the present invention has been described above in terms of one or more preferred embodiments and methods. It is recognized that various alternatives and modifications can be made to these embodiments and methods that are within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention. The present invention, therefore, is intended to be limited only by the scope of the appended claims.

1. A flipper assembly for use with a thermoforming mold comprising:
a base mounted to the mold; and
a flipper arm having a three-dimensionally contoured feature molding surface configured for molding a feature into a molded component formed in the thermoforming mold, the flipper arm connected by a pivot to the base and configured for pivotable movement between a molding position and a molded component release facilitating position disposed distal from the molding position.

2. The flipper assembly of claim 1, wherein the flipper arm is disposed in a generally horizontal position when disposed in the molding position and configured to pivot upwardly towards a molded component release facilitating position during demolding of a molded component formed in the thermoforming mold.

3. The flipper assembly of claim 2, wherein the flipper arm is configured with a center of gravity disposed forwardly of the pivot providing a flipper arm return force vector configured for urging the flipper arm to return to the molding position when the flipper arm is disposed in a molded component release facilitating position.

4. The flipper assembly of claim 3, further comprising a flipper arm return force biasing element extending between the flipper arm and the base configured to provide another force vector urging the flipper arm to return to the molding position when the flipper arm is disposed in a molded component release facilitating position.

5. The flipper assembly of claim 4, wherein the flipper arm return force biasing element comprises a flipper arm return spring configured to return the flipper arm to the molding position.

6. The flipper assembly of claim 5, wherein the flipper arm return spring comprises an elongate coil spring operatively coupled in tension to the flipper arm and base.

7. The flipper assembly of claim 6, wherein the flipper arm return spring is housed within the flipper arm and the base; wherein the flipper arm has a spring receiving conduit formed therein in which one portion of the flipper arm return spring is received therein; and wherein the base has a spring receiving conduit formed therein in which another portion of the flipper arm return spring is received therein.

8. The flipper assembly of claim 7, further comprising a first spring anchor carried by the flipper arm to which one end of the flipper arm return spring is attached, a second spring anchor carried by the base to which an opposite end of the flipper arm is attached, and wherein the flipper arm return spring contacts no portion of the flipper arm and base when the flipper arm is pivoted between the molding position and a molded component release facilitating position.

9. The flipper assembly of claim 8, wherein the pivot comprises an elongate cylindrical pin pivotably connecting the flipper arm to the base, first spring anchor comprises an elongate generally cylindrical pin carried by the flipper arm, and second spring anchor comprises an elongate generally cylindrical pin carried by the base.

10. The flipper assembly of claim 1, wherein the three-dimensionally contoured feature molding surface projects outwardly from part of the flipper arm and from the base when the flipper arm is disposed in the molding position.

11. The flipper assembly of claim 10, wherein the three-dimensionally contoured feature molding surface is configured to form an undercut in a molded component formed in the thermoforming mold.

12. The flipper assembly of claim 12, wherein the three-dimensionally contoured feature molding surface is configured to form a finger or flipper.

13. The flipper assembly of claim 1, wherein the flipper arm is gravity actuated between the molded position and a molded component release facilitating position disposed distal from the molding position.

14. The flipper assembly of claim 13, wherein gravity acting on a center of gravity of the flipper arm produces a gravity actuated return force on the flipper arm opposing pivoting of the flipper arm away from the molded position.

15. The flipper assembly of claim 1, further comprising a biasing element that actuates the flipper arm between the molded position and a molded component release facilitating position disposed distal from the molding position.

16. The flipper assembly of claim 14, wherein the biasing element produces a biasing element actuated return force on the flipper arm opposing pivoting of the flipper arm away from the molded position.

17. The flipper assembly of claim 17, wherein the biasing element comprises an elongate coil spring operatively connecting the flipper arm to the base.

18. A flipper assembly for use with a thermoforming mold comprising:
a base mounted to the mold;
a flipper arm pivotably connected to the base; and
a spring having a first end attached to the base and a second end attached to the flipper arm;
wherein a sheet is pressed against the base and the flipper arm when the sheet is formed into the package; and
wherein the flipper arm is pivoted relative to the base after a sheet is formed into a package.

19. The flipper assembly of claim 18, wherein the arm is pivotable between:
a first position where the arm is substantially perpendicular to the height of the base; and
a second position where the arm is substantially parallel to the height of the base.

20. The flipper assembly of claim 19, wherein the flipper arm is moved from the first position to the second position after the thermoforming process; and
wherein the flipper arm is returned to the first position after the package has been disengaged from the flipper arm by the spring.

21. The flipper assembly of claim 20, wherein the spring extends in a purely linear fashion between the first position to the second position.

22. The flipper assembly of claim 20, wherein the spring retracts in a purely linear fashion between the second position to the first position.

23. The flipper assembly of claim 18, wherein the flipper arm forms a finger in an undercut that is formed in the sheet.

24. The flipper assembly of claim 18, further comprising a first pin extending through a portion of the base and the flipper arm;
wherein the flipper arm pivots about the first pin when the package is disengaged from the flipper arm.

25. The flipper assembly of claim 24, further comprising:
a second pin extending through a portion of the base;
a third pin extending through a portion of the flipper arm; and
wherein the second pin extends through the first end of the spring; and
wherein the third pin extends through the second end of the spring.

26. The flipper assembly of claim 18, wherein the flipper arm rotates relative to the base when the package is removed.

27. The flipper assembly of claim 18, wherein the base further comprises:
a front side; and
at least one ridge extending from the first side;
wherein the at least one ridge forms ridges in the package; and
wherein the flipper arm comprises a finger extending therefrom.

28. The flipper assembly of claim 27, wherein the sheet is compressed against the at least one ridge and the finger during the thermoforming process.

29. A method of thermoforming a sheet into a package comprising the steps of:
placing a sheet of material into a mold having a flipper assembly mounted therein, wherein the flipper assembly comprises:
a base with a front wall;
a flipper arm that is pivotably connected to the mold between:
a retracted position; and
a deployed position; and
a spring with a first end mounted to the base and a second end mounted to the flipper arm;
wherein the sheet rests on the flipper arm;
applying a pressure differential to create a suction of the sheet against the flipper assembly;
forming a package against the front wall and the flipper arm, wherein an undercut is formed where the sheet is pressed against a front edge of the flipper arm;
rotating the flipper arm from the retracted position to the deployed position to release the package from the flipper assembly without distorting the package; and
rotating the flipper arm to the retracted position by the spring.

30. The method of claim 29, wherein the base and the flipper arm constitute a cross-sectional profile; and
wherein the shape of the package is substantially the same shape as the cross-sectional profile.

31. The method of claim 29, further comprising the steps of:
extending the spring in a linear fashion when the flipper arm is pivoted from the retracted position to the deployed position; and
retracting the spring in a linear fashion when the flipper arm is pivoted from the deployed position to the retracted position.

32. A flipper assembly for use with a package-producing mold comprising:
a base mounted to the mold;
a flipper arm pivotably connected to the base;
a spring having a first end and a second end;
a first pin extending through the first end of the spring and the base;
a second pin extending through the second end of the spring and the flipper arm;
wherein a sheet is pressed against the base and the flipper arm when the sheet is formed into the package; and
wherein the flipper arm is pivoted relative to the base after a sheet is formed into a package.

33. The flipper assembly of claim 32, wherein the first pin and the second pin are vertically offset from one another.

34. The flipper assembly of claim 33, wherein the spring extends and retracts between the first pin and the second pin in a purely linear fashion.

35. The flipper assembly of claim 34, wherein the flipper arm is pivotable between:
a first position where the arm is substantially perpendicular to the height of the base; and
a second position where the arm is substantially parallel to the height of the base.

36. The flipper assembly of claim 18, wherein the flipper arm is moved from the first position to the second position after the thermoforming process; and
wherein the flipper arm is returned to the first position after the package has been disengaged from the flipper arm by the spring.

37. The flipper assembly of claim 33, further comprising a third pin extending through the base and the flipper arm;
wherein the third pin serves as a pivot point of the flipper arm.
